(19) United States
(12) Patent Application Publication
(10) Pub. No.: US 2005/0272014 A1
(43) Pub. Date: Dec. 8, 2005

(54) Method for increasing mindful awareness of positive life elements

(76) Inventor: Laura J. Graham, Tigard, OR (US)

Correspondence Address: TIMOTHY E SIEGEL, 1868 KNAPPS ALLEY, SUITE 206, WEST LINN, OR, 97068, US

(21) Appl. No.: 10/848,249

(22) Filed: May 18, 2004

(51) Int. Cl. G09B 19/00

(52) U.S. Cl. 434/236

(57) ABSTRACT

A method of increasing mindful awareness of a subset of positive life elements, chosen from a set of life elements. The method makes use of a mindful awareness assembly, having a set of articles, each article bearing at least one abstract designator indicating at least one of the set of life elements and a display unit, for displaying at least a subset of the articles. The user selects a subset of the set of articles and places the subset in the display unit, thereby creating a display of the subset of the articles. Finally, the user views the display and quietly reflects upon the subset of positive life elements indicated.

### BACKGROUND OF THE INVENTION

In our busy world of social contact and commerce, it may be easy to become absorbed in the competitive strains of life, to the detriment of one's overall emotional balance. Over time many different techniques have been developed to help people restore emotional balance. One technique, meditation, takes many forms and may be used to cultivate a mindful awareness of positive factors in one's life. The act of meditating may help prevent a person from becoming absorbed in negative events and the detrimental emotions they inspire by enabling a person to maintain balance and perspective in their life.

U.S. Pat. No. 3,940,863 discloses a device for creating an evocative display of articles representing life elements. These life elements are not all positive, however. Moreover, this device does not create an attractive display that lends itself to a calm, overall mindful awareness of the life elements, but rather is used to play a game designed to stimulate a psychological process. There is no mention in this reference of reflecting upon the set of life elements.

U.S. Pat. No. 4,358,013 discloses a meditation supporting device in which a transparent receptacle receives and retains a set of capsules, each capsule containing a piece of paper with a subject for meditation written upon it. Unfortunately, this device does little to create a pleasant environment for meditation or to visually remind the meditating person of the subjects of the meditation.

U.S. Pat. Nos. 5,167,565 and 5,435,726 both have to do with creating a display of articles that is designed to hold the interest of an infant or young child. There is no mention, however, of using the display as a facilitator for mindfulness.

U.S. Pat. No. 5,435,726 discloses a storytelling game that includes an extensive set of symbol bearing stones. There is no teaching, however, of selectively grouping these stones together to form a collective symbolic display.

### SUMMARY OF THE INVENTION

In a first separate aspect, the present invention is a method of increasing mindful awareness of a subset of positive life elements, chosen from a set of life elements. The method makes use of a mindful awareness assembly, having a set of articles, each article bearing at least one abstract designator indicating at least one of the set of life elements and a display unit, for displaying at least a subset of the articles. The user selects a subset of the set of articles and places the subset in the display unit, thereby creating a display of the subset of the articles. Finally, the user views the display and quietly reflects upon the subset of positive life elements indicated.

In a second separate aspect, the present invention is a method of creating a display of decorative articles bearing symbolic importance. The method makes use of a symbolic display creation assembly, having a set of decorative articles, each of which bears at least one abstract designator that has been assigned a symbolic importance. Also included is a display unit, for displaying at least a subset of the articles. The user selects a subset of the set of decorative articles and places them in the display unit, thereby creating a display of decorative articles bearing symbolic importance.

In a third separate aspect, the present invention is a decorative and symbolic display creation assembly having a set of decorative articles, each article bearing at least one abstract designator of a positive life element. Also included is a display unit, for displaying at least a subset of the articles and a key, assigning a symbolic importance to each abstract designator.

In a fourth separate aspect the present invention is a method of creating a celebratory display, for appreciation by a group of celebrants marking an event or circumstance worthy of celebration. The method makes use of a celebratory display assembly, having a set of natural articles, each bearing at least one abstract designator indicating at least one of the items that may be celebrated and a display unit, for displaying at least a subset of the natural articles. The user selects a subset of the natural articles having designators that are related to the event or circumstance worthy of celebration and places the subset of natural articles in the display unit, thereby creating a celebratory display. The celebratory display is then placed in a location where it can be appreciated by a group of celebrants.

The foregoing and other objectives, features and advantages of the invention will be more readily understood upon consideration of the following detailed description of the preferred embodiment(s), taken in conjunction with the accompanying drawings.

### BRIEF DESCRIPTION OF THE DRAWINGS

FIG. 1 is a perspective view of a portion of a mindfulness assembly, showing a display element a subset of display articles.

FIG. 2 is a perspective view of the display element of FIG. 1, showing a symbol embossed on the display element.

FIG. 3 is an illustration of a key that may form a part of the mindfulness assembly of FIG. 1, showing a symbol set for use on the decorative articles.

### DETAILED DESCRIPTION OF THE PREFERRED EMBODIMENT(S)

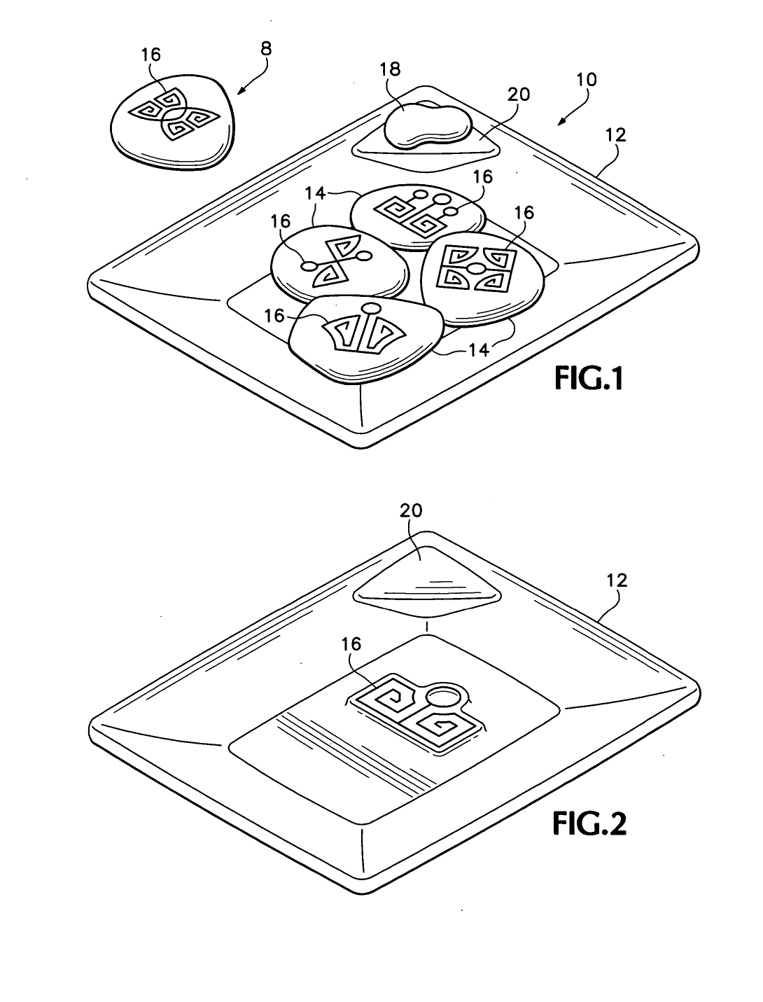

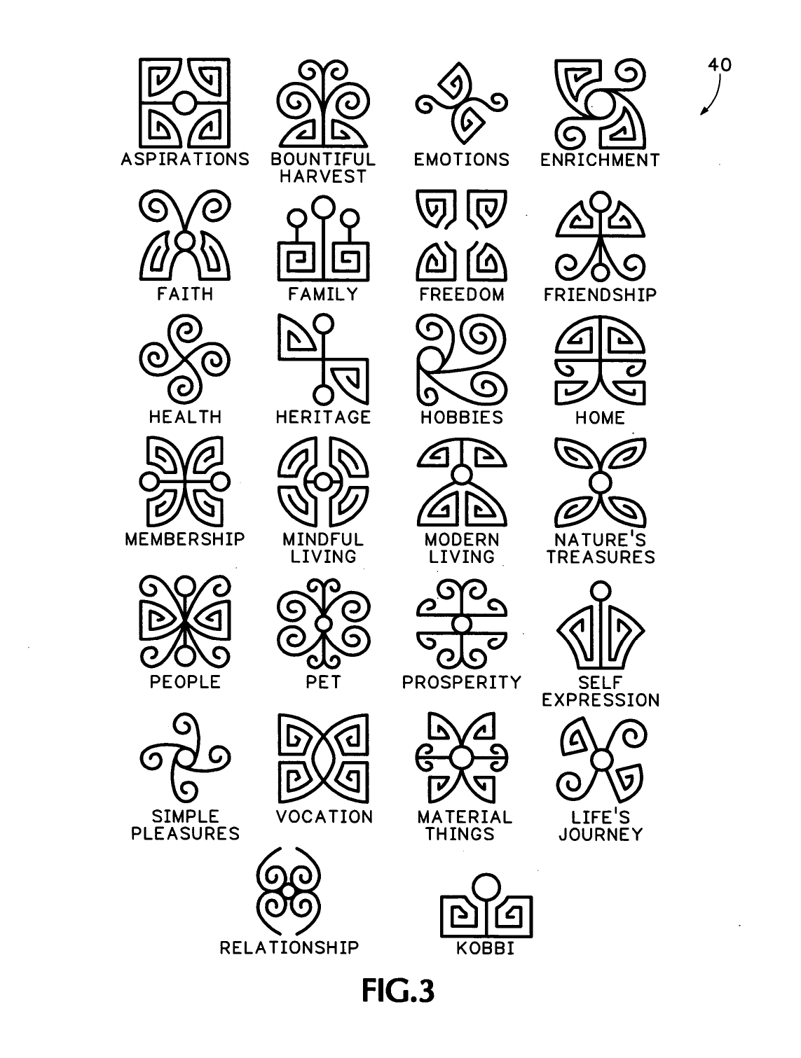

Referring to FIG. 1, in a preferred embodiment, the present invention is an assembly 8 permitting a decorative display of symbolic importance 10 to be created. The assembly 8 includes a display unit 12, which may be in the form of a rectangular ceramic plate, and a set of articles 14, each engraved with a symbol 16 representing a positive life element. In one preferred embodiment display unit 12 bears a symbol 16, which may be embossed on the surface of unit 12. The symbol 16 used may be the “kobbi” symbol, which may represent any and all positive life elements.

Articles 14 may be smooth stones, and more particularly polished Chinese river rock, which generally includes stones having many different soft natural hues. Each stone is of a size that could fit into the palm of a small child.

In one preferred embodiment a beacon element 18, which may be a substantially clear stone, may be included in the assembly 8 and in the decorative display 10. A special shelf 20 in the display unit 12 is adapted to hold beacon element 18, or one of the symbol bearing stones 14 that the user wishes to emphasize in the display 10. For example, if the user realizes that he is taking his home for granted, he may place an element 14, bearing the symbol indicating “home,” on the shelf 20, to be reminded of the positive effect on his life provided by his home.

In addition to being reminded of each of the life elements represented in a display 10 individually, a user is also reminded of the general abundance of his or her life represented by the collection of elements 14. In some instances display unit 12 will be full or even overflowing with elements 14, serving to remind the user to appreciate life's abundance.

Beacon element 18 serves to call attention to the display 10 and may act to visually engage the user and encourage him or her to meditate. Element 18 may also be used as a focus point by a user concentrating on the decorative display.

In an alternative preferred embodiment the display unit 12 is made of some natural material other than ceramic. For example unit 12 could be made of wood, stone, glass or wax. This range of materials also could be used for making articles 14. Additional materials that can be used for unit 12 and/or articles 14 are basket material, cloth, stuffed cloth, stainless steel, polished brass, aluminum, glass and polymer resin (for example white resin, resembling ivory). In one preferred embodiment, articles 14 are candles. Also, display unit 12 can be partially filled with water, and articles 14, made lighter than water, can be floated on the water.

FIG. 2 shows a key 40 that may be a part of assembly 8. Key 40 shows one preferred symbol set together with an assigned symbolic importance for each symbol. It should be emphasized that assembly 8 need not include a stone for each of the symbols shown in key 40. In one preferred embodiment four stones 14 are included in assembly 8. The subset of stones 14 used to form the display of symbolic importance may include all of the stones 14 of assembly 8. This comports with the mathematical definition of a subset, which may include all of the elements of a set.

It would currently be generally advisable to include a key 40 with an assembly 8 to prompt the user toward a particular way of using the assembly 8. If the symbol set of key 40, or a subset of this symbol set should become well known however, this would no longer be necessary as the symbolic importance of each symbol might be known to a prospective purchaser prior to obtaining the assembly 8.

In a preferred method, assembly 8 is used to create a decorative display bearing symbolic importance. The user looks through his or her set of elements 14 and chooses which ones to include in display 10, based on personal criteria. Some users may choose elements 14 designating life elements for which he is particularly thankful at the moment. Another user may choose elements 14 for which she feels a need to be reminded of the possibility of thankful appreciation. Another user may choose elements 14 based on the aesthetics of a set of elements 14 (for example, the colors of the stones) or of the aesthetics of the symbols 16 that they bear.

After assembling a display 10 a user may sit in mindful, quiet meditation for a period of time, depending on the form of meditation. The user may listen to quiet music, new age music or nature sounds as she meditates.

Assembly 8 may also be used for a sort of subtle communication/celebration process. For example, if a user's investment club is meeting at the user's dwelling place, the user may arrange a display 10 to include the enrichment stone, the bountiful harvest stone, the prosperity stone, the aspirations stone, the material things stone and the friendship stone, to form a celebratory display for the other members of the group to appreciate.

The terms and expressions that have been employed in the foregoing specification are used as terms of description and not of limitation. There is no intention, in the use of such terms and expressions, of excluding equivalents of the features shown and described or portions thereof, it being recognized that the scope of the invention is defined and limited only by the claims which follow.

1. A method of increasing mindful awareness of a subset of positive life elements, chosen from a set of positive life elements, comprising:
(a) providing a mindful awareness assembly, having:
(i) a set of articles, each article bearing at least one abstract designator indicating at least one of said set of positive life elements;
(ii) a display unit, for displaying at least a subset of said articles;
(b) selecting a subset of said set of articles and placing said subset in said display unit, thereby creating a display of said subset of said articles; and
(c) viewing said display and quietly reflecting upon said subset of positive life elements.

2. The method of claim 1 wherein said articles are solid and have a specific gravity of greater than 1.

3. The method of claim 2 wherein said articles are stones.

4. The method of claim 3 wherein said abstract symbols are etched upon said stones.

5. The method of claim 2 wherein said articles are ceramic tiles.

6. The method of claim 1 wherein said articles are made of a natural material.

7. The method of claim 5 wherein said articles are made of wood.

8. The method of claim 1 wherein said mindful awareness assembly includes a key that assigns a life element to each abstract indicator.

9. The method of claim 1 wherein each abstract indicator indicates a particular life element to a subset of the population.

10. A method of creating a display of natural and decorative articles bearing symbolic importance, comprising:
(a) providing a symbolic display creation assembly, having:
(i) a set of decorative articles, each article bearing at least one abstract designator that has been assigned a symbolic importance;
(ii) a display unit, for displaying at least a subset of said articles;
(b) selecting a subset of said set of articles and placing said subset in said display unit, thereby creating a display of decorative articles bearing symbolic importance.

11. The method of claim 10 wherein said articles have the appearance of being made of a naturally occurring material.

12. The method of claim 10 wherein said articles are made of a naturally occurring material.

13. The method of claim 12 wherein said articles are made of stone.

14. A decorative and symbolic display creation assembly, having:
(a) a set of decorative articles, each article bearing at least one abstract designator of a positive life element;
(b) a display unit, for displaying at least a subset of said articles; and
(c) a key, assigning a symbolic importance to each abstract designator.

15. The decorative and symbolic display creation assembly of claim 14, further including an article that does not bear an abstract designator and which may be used to mark a completed display.

16. The decorative and symbolic display creation assembly of claim 15, wherein said article that does not bear an abstract designator is substantially clear.

17. The decorative and symbolic display creation assembly of claim 14 wherein one of said abstract designators includes a circle having a bottom, a vertical line extending downwardly from said circle bottom and having a vertical line bottom, a horizontal line which meets said vertical line at said vertical line bottom and has two opposed ends and two vertical lines extending upwardly, one from either end of said horizontal line.

18. A method of creating a celebratory display, for appreciation by a group of celebrants marking an event or circumstance worthy of celebration:
(a) providing a celebratory display assembly, having:
(i) a set of natural articles, each bearing at least one abstract designator indicating at least one of item that may be celebrated;
(ii) a display unit, for displaying at least a subset of said natural articles;
(b) selecting a subset of said natural articles having designators that are related to said event or circumstance worthy of celebration and placing said subset of natural articles in said display unit, thereby creating a celebratory display; and
(c) placing said celebratory display in a location where it can be appreciated by a group of celebrants.
